(19) United States
(12) Patent Application Publication
(10) Pub. No.: US 2026/0236010 A1
(43) Pub. Date: Aug. 13, 2026

(54) Systems and Methods for Automated Manufacturing Tool Controls

(71) Applicant: Newfrey LLC, New Britain, CT (US)

(72) Inventors: Pradeep Reddy ARE, Novi, MI (US); Stanley L. BISHOP, Lincoln Park, MI (US)

(73) Assignee: Newfrey LLC, New Britain, CT (US)

(21) Appl. No.: 19/048,075

(22) Filed: Feb. 7, 2025

(51) Int. Cl. G05B 19/418

(52) U.S. Cl. CPC G05B 19/4184; G05B 2219/1181

(57) ABSTRACT

An example system includes an automated manufacturing tool device of an assembly line, a fieldbus module, and a controller including memory and at least one processor configured to receive input/output (I/O) frames via the fieldbus module and maintain a queue of I/O frames in memory, each I/O frame including a status of at least one I/O signal associated with the automated manufacturing tool device, and in response to a trigger, write contents of the queue of I/O frames to persistent storage as a binary file, copy a bitmap configuration file to the persistent storage according to a currently selected bitmap configuration, write a metadata file to the persistent storage, the metadata file including metadata associated with the queue of I/O frames and the bitmap configuration file, and display contents of the queue of I/O frames on a plot on a human-machine interface of the controller.

### FIELD

The present disclosure relates systems and methods for automated manufacturing tool controls.

### BACKGROUND

During equipment buyoffs, line building and commissioning, issues often arise where technicians and controls engineers need to troubleshoot timing or logical discrepancies in the handling of input/output (IO) signals between a tool system, robot and programmable logic controller (PLC). Some tool systems offer a mechanism to view an immediate state of IO signals, although in many cases this is not sufficient for determining a root cause of a discrepancy in differences of milliseconds over multiple signal states.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An example system includes an automated manufacturing tool device of an assembly line, a fieldbus module in communication with a robot or programmable logic controller (PLC), and a controller including memory configured to store computer-executable instructions, and at least one processor configured to execute the computer-executable instructions to receive input/output (I/O) frames via the fieldbus module and maintain a queue of I/O frames in memory, each I/O frame including a status of at least one I/O signal associated with the automated manufacturing tool device, and in response to a trigger, write contents of the queue of I/O frames to persistent storage as a binary file, copy a bitmap configuration file to the persistent storage according to a currently selected bitmap configuration, the bitmap configuration file including at least one parameter of the at least one I/O signal, write a metadata file to the persistent storage, the metadata file including metadata associated with the queue of I/O frames and the bitmap configuration file, and display contents of the queue of I/O frames on a plot on a human-machine interface of the controller.

In some examples, the trigger is an input received at the human-machine interface to generate a plot of the contents of the queue of I/O frames. In some examples, the trigger is a detected fault in at least one component of the assembly line. In some examples, the trigger is at least one of a detected fault, a detect warning, or a detected event, in the automated manufacturing tool device.

In some examples, bitmap configuration file includes a location of each I/O signal within an I/O frame, a length of each I/O signal within an I/O frame, and a data type of each I/O signal within an I/O frame.

In some examples, the metadata file is stored as a JavaScript Object Notation (JSON) file in persistent storage. In some examples, the metadata file includes a timestamp, a trigger source, a firmware version, a file name of the bitmap configuration file, a selected file name of the bitmap configuration file, a duration of the contents of the queue of I/O frames, a name of a stored record, and a checksum of the binary file.

In some examples, writing contents of the queue of I/O frames includes writing contents of the queue of I/O frames to a temporary directory in the persistent storage.

In some examples, the at least one processor is configured to execute the computer-executable instructions to compress contents of the temporary directory to a zip file in the persistent storage.

In some examples, the at least one processor is configured to execute the computer-executable instructions to compare a size of the queue of I/O frames to a maximum queue size value, and in response to the size of the queue of I/O frames reaching the maximum queue size value, replace an oldest I/O frame in the queue with a newest I/O frame in a first-in first-out manner. In some examples, types of automated manufacturing tool device is a self-piercing rivet tool or weld tool.

In some examples, the at least one processor is configured to execute the computer-executable instructions to display a list of bitmap configuration on the human-machine interface for selection by a user, receive an input selection of a subset of signals from the bitmap configuration, and display only the subset of signals selected by the user on the plot on the human-machine interface. In some examples, a resolution of the plot is less than or equal to one millisecond.

An example method includes receiving input/output (I/O) frames via a fieldbus module in communication with a robot or PLC, and maintain a queue of I/O frames in memory, each I/O frame including a status of at least one I/O signal associated with the automated manufacturing tool, and in response to a trigger, writing contents of the queue of I/O frames to persistent storage as a binary file, copying a bitmap configuration file to persistent storage according to a currently selected bitmap configuration, the bitmap configuration file including at least one parameter of the at least one I/O signal, writing a metadata file to persistent storage, the metadata file including metadata associated with the queue of I/O frames and the bitmap configuration file, and displaying contents of the queue of I/O frames on a plot on a human-machine interface.

In some examples, the trigger is an input received at the human-machine interface to generate a plot of the contents of the queue of I/O frames. In some examples, the trigger is a detected fault in at least one component of the assembly line.

In some examples, the trigger is at least one of a detected fault, a detected warning or a system event, in at least one component of the assembly line.

In some examples, the bitmap configuration file includes a location of each I/O signal within an I/O frame, a length of each I/O signal within an I/O frame, and a data type of each I/O signal within an I/O frame. In some examples, the metadata file is stored as a JavaScript Object Notation (JSON) file in memory.

In some examples, the metadata file includes a timestamp, a trigger source, a firmware version, a selected file name of the bitmap configuration file, a duration of the contents of the queue of I/O frames, a name of a stored record, and a checksum of the binary file.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system for troubleshooting timing or logical discrepancies in the handling of input/output (IO) signals for automated manufacturing tool devices.

FIG. 2 is a functional diagram of an example system including an automated manufacturing tool device.

FIG. 3 is a functional block diagram of an example for a fieldbus input/output signal exchange control board, which may be deployed within the system of FIG. 1.

FIG. 4 is an example display screen for selecting input/output signals of an automated manufacturing tool device system for display.

FIG. 5 is an example display for plotting input/output signals of an automated manufacturing tool device system for troubleshooting.

FIG. 6 is another example display for plotting input/output signals of an automated manufacturing tool device system for troubleshooting.

FIG. 7 is another example display screen for selecting input/output signals of an automated manufacturing tool device system for display.

FIG. 8 is an example display of signal properties for input/output signals of an automated manufacturing tool device.

FIG. 9 is a flowchart depicting an example process for displaying contents of a queue of input/output frames on a plot of a human machine interface of a controller of an automated manufacturing tool.

In the drawings, reference numbers may be reused to identify similar and/or identical elements.

### DETAILED DESCRIPTION

In some example embodiments described herein, in order to better facilitate validation of Input/Output (IO) signal handling, such as in control systems for automated manufacturing tool devices, an IO signal tracing feature may be integrated in to a human-machine interface of the tool system. The feature may allow users to save a record of recent IO changes, and analyze them via a temporal visualization (e.g., similar to a black box flight data recorder).

For example, upon power up, the device may continuously buffer in memory (e.g., up to three Megabytes, or more or less), the most recent IO state changes using a specified time resolution (such as ten milliseconds, or more or less). The change buffer may be written to a record file, such as when directly triggered via the HMI by a user, or automatically triggered by the occurrence of a fault. Along with the change buffer, a record may also include metadata with details about the device's current software versions, IO bitmap configuration, creation date, trigger source, etc.

When a user opens a record, a table may be displayed with each signal name, the type (Input/Output) of the signal, the bitmap location, the number of changes recorded, etc. Users may then select a time period, individual signals, and an order in which they wish to display the signals on a timing chart.

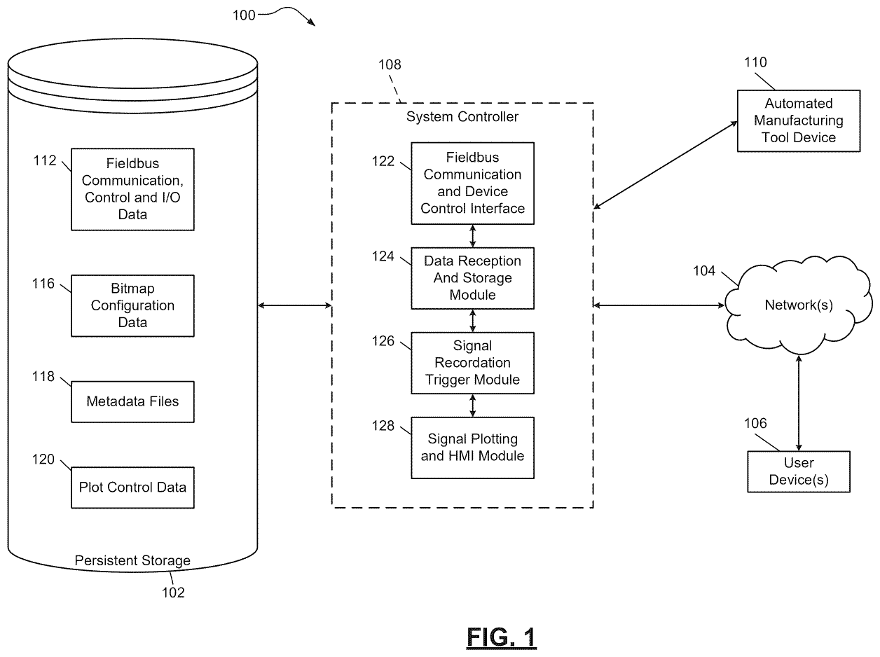

FIG. 1 is a functional block diagram of an example system 100 for troubleshooting timing or logical discrepancies in the handling of input/output (IO) signals for automated manufacturing tool devices, which includes persistent storage 102. While the system 100 is generally described as being deployed in a computer network system, such as a control system for automated manufacturing tool devices of an assembly line, the persistent storage 102 and/or components of the system 100 may otherwise be deployed (for example, as a standalone computer setup). The system 100 may include a desktop computer, a laptop computer, a tablet, a smartphone, etc.

As shown in FIG. 1, the persistent storage 102 stores fieldbus communication, control and I/O data 112, bitmap configuration data 116, metadata files 118, and plot control data 120. In various implementations, the persistent storage 102 may store other types of data as well. The fieldbus communication, control and I/O data 112, bitmap configuration data 116, metadata files 118, and plot control data 120 may be located in different physical memories within the persistent storage, such as different random access memory (RAM), read-only memory (ROM), a non-volatile hard disk or flash memory, one or more database, etc. For example, some data may be stored on servers of a third party vendor.

In some implementations, the fieldbus communication, control and I/O data 112, bitmap configuration data 116, metadata files 118, and plot control data 120 may be located in the same memory (such as in different address ranges of the same memory). In various implementations, the fieldbus communication, control and I/O data 112, bitmap configuration data 116, metadata files 118, and plot control data 120 may each be stored as structured data in any suitable type of data store.

The fieldbus communication, control and I/O data 112 may include any suitable data including I/O signals, control signals, data transmitted to or from an automated manufacturing tool device (such as via a fieldbus connection or programmable logic controller), etc. The bitmap configuration data 116 may include any data suitable for describing a bitmap of different signals in the system, such as which bits correspond to which signal components, and are associated with which automated manufacturing tool devices or which I/O or control signals.

The metadata files 118 may include any suitable metadata about the I/O signals, control signals, automated manufacturing tool devices, etc. The plot control data 120 may include any suitable data for controlling aspects of plotting selected signals, such as different time periods for plotting, different formats of graphs plots, different colors of plot lines, different axis sizes, labels and tick marks, etc.

As shown in FIG. 1, the system 100 includes a system controller 108. The system controller 108 may include one or more modules for troubleshooting timing or logical discrepancies in the handling of input/output (IO) signals for automated manufacturing tool devices. For example, a fieldbus communication and device control interface 122 may facilitate transmission of control signals and I/O signals to and from an automated manufacturing tool device 110.

A data reception and storage module 124 may be configured to receive and store data, such as by receiving IO and control signals from a robot or PLC. The data reception and storage module 124 may then store the received data in one or more persistent storage locations.

The signal recordation trigger module 126 may be configured to initiate capture of IO signals from the robot or PLC. For example, the signal recordation trigger module 126 may facilitate setting a recordation trigger based on user input, based on a detected fault in the system 100, based on occurrence of a specified event in the system 100, etc.

The signal plotting and human-machine interface (HMI) module 128 may operate by displaying a configurable plot of IO signals from the automated manufacturing tool device 110. For example, the signal plotting and HMI module 128 may be configured to allow users to select which IO signals to plot, which may be based on the bitmap configuration data 116. The signal plotting and HMI module 128 may be configured to allow users to select time periods for plotting, colors for different signals, an order of displayed signals and names for the displayed signals, etc.

In some examples, users may interact with the system 100 via a user device 106. The user device 106 may include any suitable user device for displaying text and receiving input from a user, including a desktop computer, a laptop computer, a tablet, a smartphone, etc. In various implementations, the user device 106 may access the persistent storage 102 or the system controller 108 directly, or may access the persistent storage 102 or the system controller 108 through one or more networks 104. Example networks may include a wireless network, a local area network (LAN), the Internet, a cellular network, etc. In some examples, the display and user interface may be part of a user interface (e.g., an HMI) of the automated manufacturing tool device 110.

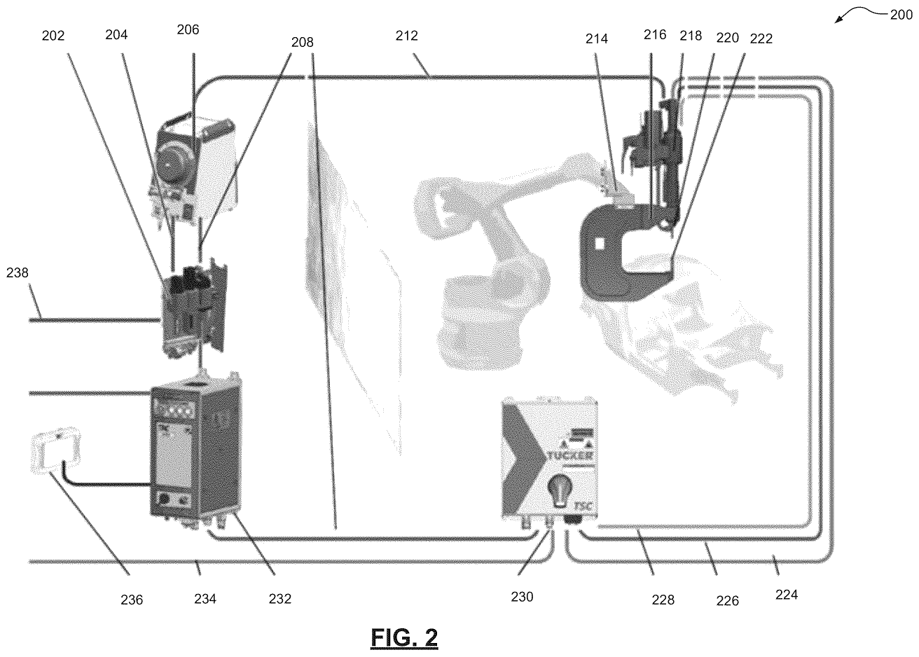

FIG. 2 is a functional diagram of an example system 200 including an automated manufacturing tool device. The automated manufacturing tool device may be any suitable manufacturing tool, such as a self-piercing rivet tool for an assembly line.

In the example illustrated in FIG. 2, the system 200 includes a compressed air control unit 202, which may be configured to control a compressed air supply to the system 200. Compressed air inlet lines 204 are configured to connect pneumatic components to the compressed air control unit 202.

The system 200 includes a self-piercing rivet feeder 206, which is configured to store rivets of different lengths, and feed them into the correct position in a receiver of the self-piecing rivet tool 218. Control lines 208 connect the control unit 208 to the peripherals, such as the self-piercing rivet feeder 206, die changer, divider, and compressed air control unit 202.

A feed tube 212 is configured to move rivets from the feeder 206 to the receiver of the self-piercing rivet tool 218. An adapter 214 is configured to connect the self-piercing rivet gun assembly to the industrial robot. The self-piercing rivet gun assembly may include the self-piercing rivet tool 218 and the C-frame 216.

The C-frame 216 supports the self-piercing rivet tool 218 and the die 222. The self-piercing rivet tool 218 may be configured to punch rivets into a workpiece, and may include a gear box, a linear motor, a DDC box, a receiver 220, and a spindle. The receiver 220 is configured to receive rivets from the feed system and hold them in the correct position under the stamp of the self-piercing rivet tool 218. The die 222 acts as a counter-holder to the punch during forced joining.

A motor cable 224 connects the servo controller 230 to the self-piercing rivet tool 218. The bus cable 226 is configured to transfer data between several participants, and the resolver cable 228 is configured to send the rotor's angular position from the self-piercing rivet tool 218 to the servo controller 230, for evaluating the speed and position in the servo amplifier's controller.

The servo controller 230 is configured to regulate the motor of the self-piercing rivet tool, and therefore the setting force. A servo controller cable connects the control unit 232 to the servo controller 230. Power may be supplied to the servo controller 230 directly from the plant supply 234.

The control unit 232 is configured to control and monitor the riveting sequence. The plant supply 234 is configured to supply the entire system 200 with voltage. The control panel 236 is optional, and may be configured for operating the control unit 232.

A control cable for a higher-level system controller may be present for product versions with control boards that connect the control unit 232 to a higher-level system controller. For example, a control network line may connect to a robot or PLC that interfaces with the fieldbus module. A compressed air supply 238 is configured to supply compressed air to all of the pneumatic components of the system 200.

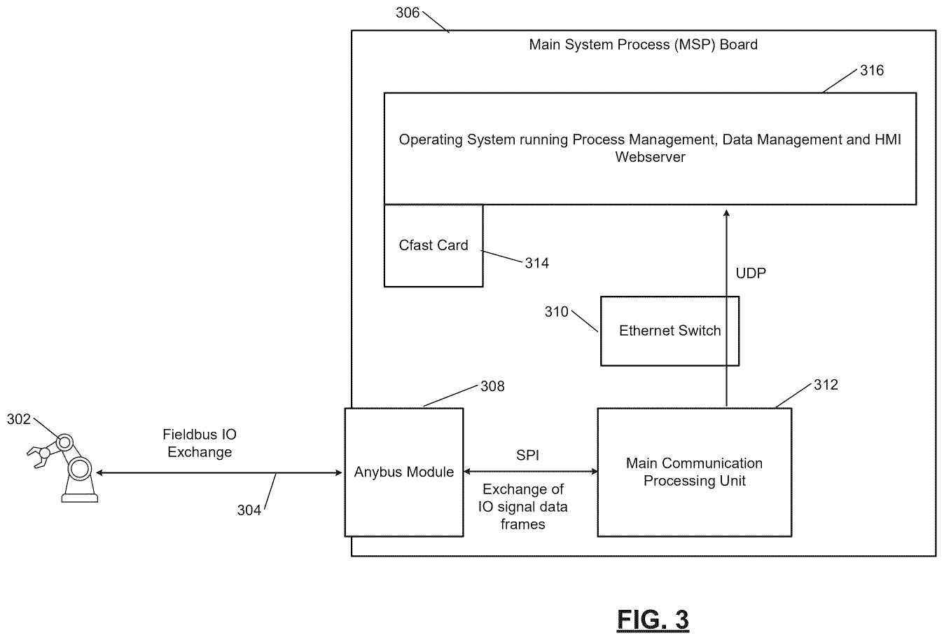

FIG. 3 is a functional block diagram of an example for a fieldbus input/output signal exchange control board, which may be deployed within the system of FIG. 1. As shown in FIG. 3, a main system process (MSP) board 306 includes a field bus communication module 308 (such as an HMS Anybus B40 module) configured to exchange fieldbus I/O signals with a robot or PLC and an automated manufacturing tool device 302 (such as a self-piercing rivet tool).

The fieldbus communication module 308 exchanges I/O signal data frames with a main communication processing unit 312, such as via an SPI interface. The main communication processing unit 312 may send signals (e.g., UDP packets) to an operating system 316, such as an IMX6 running a Linux OS and computer programs/applications for process management, data management, and an HMI webserver.

In some examples, the main communication processing unit 312 may send signals using an Ethernet switch 310, or other suitable communication bus or wires. A CFast card may be coupled with, or included in, the operating system component 316, for storing I/O frames in response to a trigger.

In various implementations, the system may be equipped with an HMS Anybus B40 fieldbus module that serves as the entry point for exchange of Input/Output signals between the control and a robot or PLC. The B40 module allows for the abstraction of any protocol specific details in the device software.

A main communication processing unit (MCPU) may interface with the B40 module. For example, the MCPU may be configured to exchange input and output data frames with the B40 module at a rate of up to 1 frame per millisecond (or more or less, dependent on the customer bus speed). As IO frames are exchanged, any frames with a difference in value may be accumulated and sent in batches over a UDP connection (or other suitable communication protocol) to the process management (PM) application running on the IMX6 chip.

The PM application may be configured to receive the frames and maintain a queue in memory of up to 3 MB of Input and Output Frames (or a smaller or larger size queue in memory). When triggered by user input via the HMI, or automatically via the occurrence of a detected system fault or event, the PM process may be configured to write the contents of the queue to a binary file in a temporary directory on a CFast card, copy the currently selected bitmap configuration file containing the location and length of each signal within an input or output frame, and write a metadata file, such as a JavaScript Object Notation (JSON) file. The metadata file may include, for example, a timestamp, a trigger source, a firmware version, a selected bitmap file name, a duration of the record in milliseconds, a file name of the record, a checksum of the binary file containing the IO frame data, etc. The PM may then zip the contents of the temporary directory. In some examples, no additional sensors are involved in the process of recording I/O frames from the queue in response to a trigger.

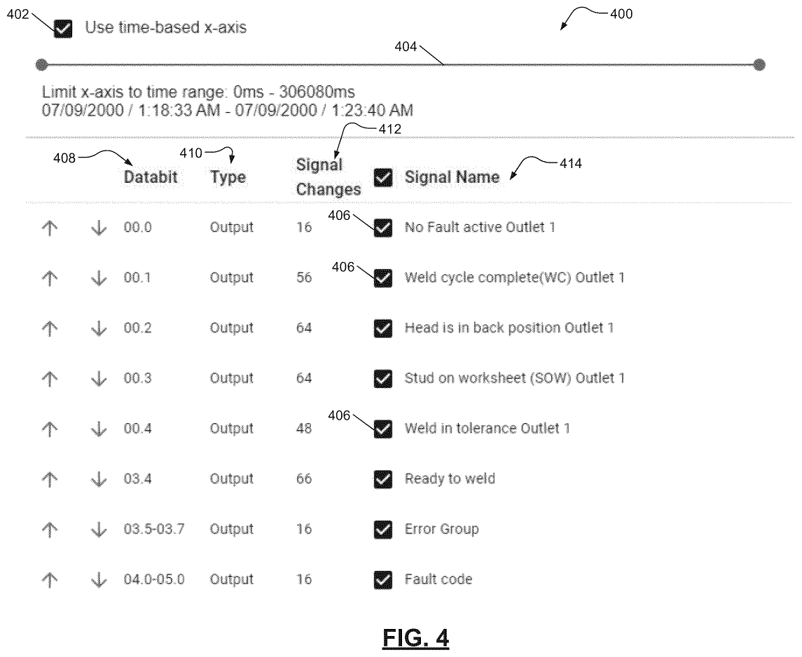

FIG. 4 is an example display screen 400 for selecting input/output signals of an automated manufacturing tool device system for display. As shown in FIG. 4, an axis toggle box 402 allows a user to decide whether they would like to use a time-based x-axis for plotting I/O signals in the system. Other options may include an event based axis, a signal change based axis, etc.

A time limit slider 404 may allow a user to scroll a desired portion of a total time range of the queue of signals, to display only a selected time range of interest. For example, after a record has been created, and before viewing, the user may adjust the time span of the plot view.

In some examples, the recording period may or may not be adjustable by the user. The queue of buffered changes starts recording when the device is powered on, and may hold up to 3 MB (or more or less) of I/O signal changes. Once the buffer is full, after the occurrence of a new I/O signal change, the oldest change may be dequeued and the latest change may be enqueued, in a first in first out manner.

The total time period of a record may not have any hard set limit. For example, if a device powered on with 1 signal change having occurred, then sat idle for days until another signal change occurs, a record triggered by the user may only have 2 changes (far less than an example maximum 3 MB buffer size), but the time duration of the record would be days long. Conversely, if a device is powered on and IO changes occur at a steady rate of 1 change every 10 milliseconds, the max number of buffered changes may be reached in just under 5 minutes (e.g., using an example 3 MB maximum buffer size).

As shown in FIG. 4, the display screen 400 includes columns for providing information regarding different I/O signals. For example, a databit 408 may indicate an address or specific bit location in I/O signal data, for identifying specific functions of the system.

A type 410 may indicate whether the I/O signal is an inputs signal for a tool, an output signal from a sensor or tool, a control or data signal, etc. A number of signal changes 412 may be displayed, to indicate how many times a specified signal changed within a time period.

A signal name 414 may be displayed to indicate various types of signal functions, and make it easier for a user to troubleshoot different signals and issues. The signal name 414 may be assigned manually by a user, may be automated based on a system setup or configuration file, etc.

Toggle boxes 406 may allow the user to decide whether or not to include a specific signal in a displayed plot of I/O signals over time. For example, if the user activates the toggle box 406 for the databit 00.1, which has a signal name 414 of ‘Weld cycle complete (WC) Outlet 1’, the plot display may include the I/O signal indicating each time that the automated manufacturing tool device output a signal representing that another weld cycle has been completed.

In various implementations, the number of signals for plotting may be determined by a selected customer interface bitmap configuration. A signal may be as small as 1 bit in an input or output frame. Some example embodiments may support up to 100 bytes per frame or more.

Plot lines and signals may be automatically assigned in some implementations (e.g., non-configurable), or may be configurable by a user in other examples. The user may select a subset of signals from the bitmap configuration (e.g., via the toggle boxes 406), and the order in which to display them on the chart or plot.

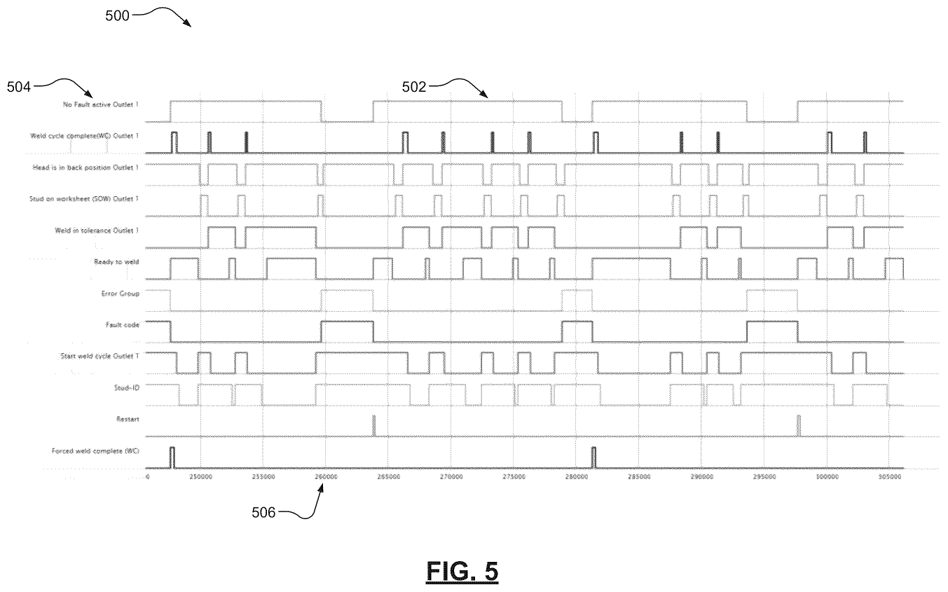

FIG. 5 is an example display 500 for plotting input/output signals of an automated manufacturing tool device system for troubleshooting. As shown in FIG. 5, the x-axis lists time values 506, and the y-axis lists signal names 504, indicating which signals are shown for each row of the plot. The signals 502 may be represented by high or low logical values, corresponding to a state of each I/O signal over time.

In some examples, the screen may be a display screen of an automated manufacturing tool device, or a control for an automated manufacturing tool device or system. The screen display may not require any physical modifications to display the plots of I/O signals.

The Human Machine Interface (HMI) may be a web-based user interface. The controller may be configured to act as a web application server, where the touchpad is a client, running a web browser in full screen. This may allow any device that has network access to the control and a web browser, such as a laptop, to display the plots or utilize any other feature of the HMI.

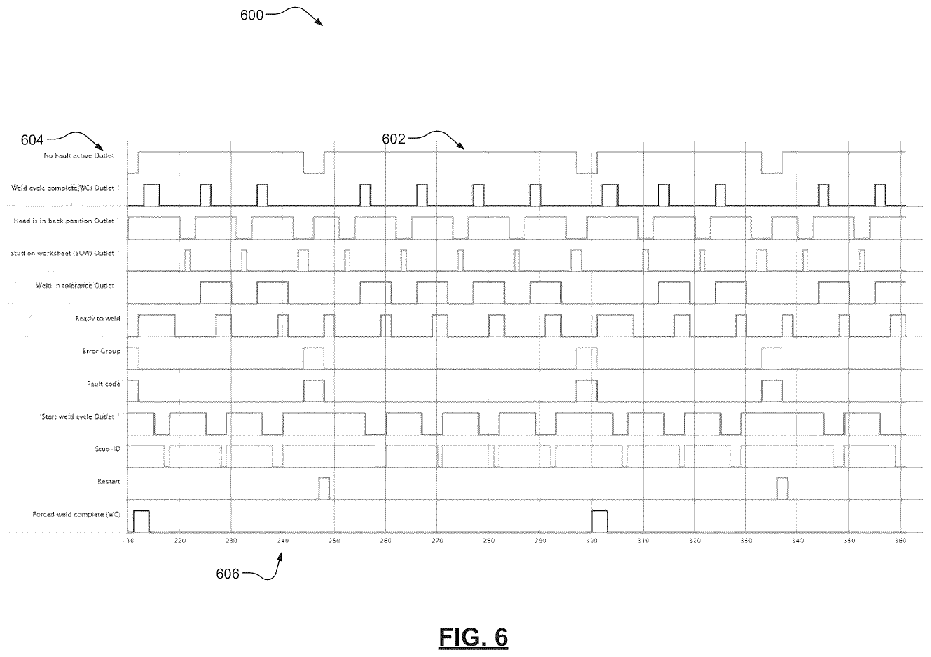

FIG. 6 is another example display 600 for plotting input/output signals of an automated manufacturing tool device system for troubleshooting. The display 600 of FIG. 6 may be similar to the display 500 of FIG. 5, with a different time scale.

For example, as shown in FIG. 6, the x-axis lists time values 606, and the y-axis lists signal names 604, indicating which signals are shown for each row of the plot. The signals 602 may be represented by high or low logical values, corresponding to a state of each I/O signal over time.

Compared with the display 500 of FIG. 5, the display 600 of FIG. 6 may show a different time range, or a similar time range after zooming in to see more detail over a shorter time period. In some, examples, depending on the customer's IO bus speed, the resolution may be up to 1 millisecond (or more or less). This may be externally adjustable by the user.

In some examples, users may adjust the plot viewing window by scrolling horizontally and pinching the plot area to zoom. Users may also double click the plot area to change the cursor to a time measurement utility. The point where the user initially double clicked may be the starting point of the time measurement. If the user touches a second point along the x-axis, the time between the two may be shown in milliseconds. The user may double click a second time to change the cursor back from measurement mode. In some examples, users may upload/download a record to view offline or transfer to another device.

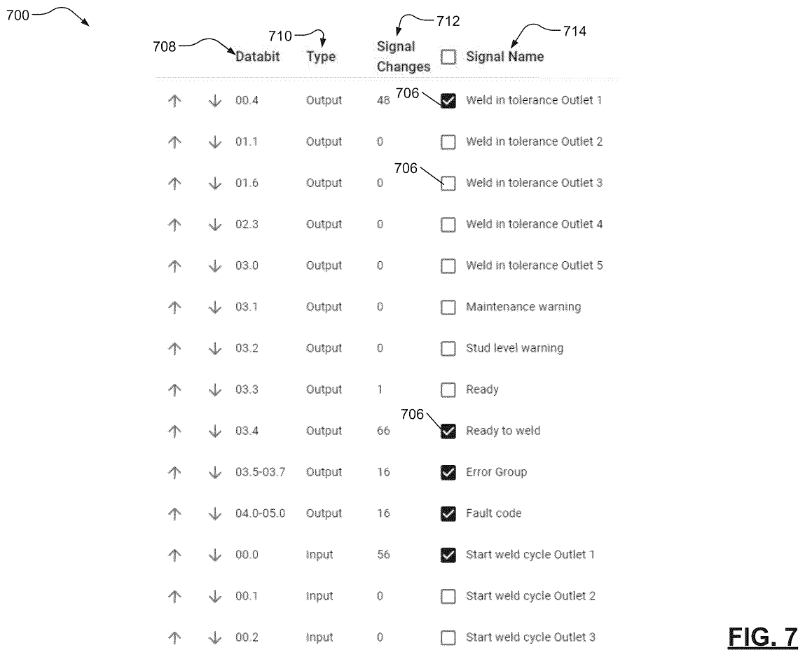

FIG. 7 is another example display screen 700 for selecting input/output signals of an automated manufacturing tool device system for display, which may be similar to the display screen 400 of FIG. 4. As shown in FIG. 7, a databit 708 may indicate an address or specific bit location in I/O signal data, for identifying specific functions of the system.

A type 710 may indicate whether the I/O signal is an inputs signal for a tool, an output signal from a sensor or tool, a control or data signal, etc. A number of signal changes 712 may be displayed, to indicate how many times a specified signal changed within a time period.

A signal name 714 may be displayed to indicate various types of signal functions, and make it easier for a user to troubleshoot different signals and issues. The signal name 714 may be assigned manually by a user, may be automated based on a system setup or configuration file, etc.

Toggle boxes 706 may allow the user to decide whether or not to include a specific signal in a displayed plot of I/O signals over time. For example, if the user activates the toggle box 706 for the databit 3.4, which has a signal name 714 of ‘Ready to weld’, the plot display may include the I/O signal indicating each time that the automated manufacturing tool device output a signal representing that the device was in a ready state to initiate another weld operation.

In some examples, to select which parameters are plotted, the user may simply check the box next to a signal name. Each time a user changes the signal selection, a persistent cookie may be used to store the selection, so that if a user stops, comes back later and opens a record with the same set of available signals, the previously selected set of signals will be preselected. The signals may be automatically labeled based on the IO bitmap configuration, although a user may upload a set of alternative signal names for the display in some examples.

Records of I/O signals may be triggered in various ways. For example, the creation of a record may be triggered manually by a user with the [Trigger Signal Record] button at the bottom of a signal recording screen, or automatically after the occurrence of a fault in the system or a detected event in the system. The system may be configured to automatically trigger the creation of a record after the occurrence of any event, or for only specified faults, warnings, firmware updates, completion of a weld/rivet cycle, etc.

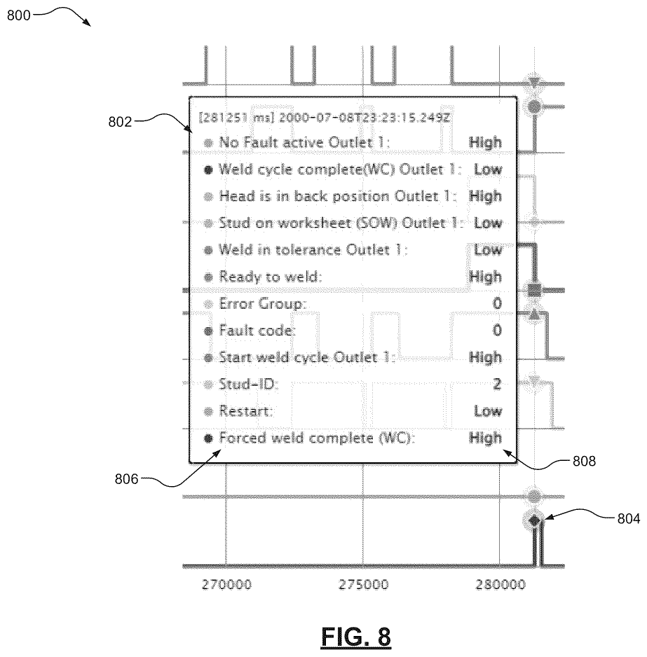

FIG. 8 is an example display 800 of signal properties for input/output signals of an automated manufacturing tool device. For example, after the values are initially plotted, the user may touch areas of the plot to show a legend-like tool tip with the state of each signal at the point in time where the user touched.

As shown in the example of FIG. 8, if a user clicks on the plot at a certain point in time, a value box 802 may be displayed to indicate a signal status 808 of each signal name 806 at that point in time. The signal status 808 for each signal may be ‘high’, ‘low’, a numerical value, etc., depending on the type of signal.

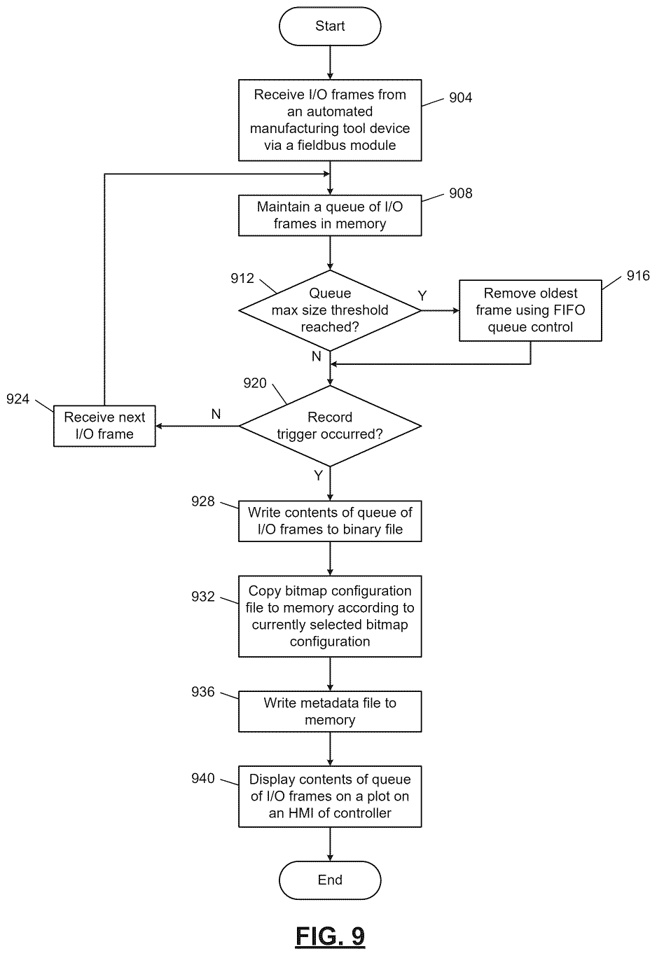

FIG. 9 is a flowchart depicting an example process for displaying contents of a queue of input/output frames on a plot of a human machine interface of a controller of an automated manufacturing tool. In various implementations, the process of FIG. 9 may be performed by one or more of the modules of the system controller 108 of FIG. 1.

At 904, the process begins by receiving input/output frames from a robot or PLC. The I/O frames may be received via a fieldbus module, for example. At 908, the system controller is configured to maintain a queue of I/O frames in memory. For example, the system controller may store the I/O frames received from the robot or PLC in a time-stamped sequence order.

The system controller may be configured to determine whether a queue maximum size threshold has been reached, at 912. For example, a queue buffer size (such as three Megabytes, or more or less) may be specified for storing a maximum among of I/O frames. If the queue maximum threshold has been reached or exceeded at 912, control may proceed to 916 to remove the oldest frame, such as in a first-in, first-out (FIFO) configuration.

At 920, the system controller is configured to determine whether a record trigger has occurred. For example, recording of I/O frames may be triggered by direct user input at an HMI of a controller of the automated manufacturing tool device, in response to a detected fault or specified event occurrence in the system, etc.

If a trigger has not occurred at 920, control proceeds to 924 to receive a next I/O frame from the automated tool manufacturing device or system. Control then returns to 908 to add the most recently received I/O frame to the queue of I/O frames in memory.

Once a trigger occurs at 920, the system controller is configured to write the contents of the queue of I/O frames to a binary file, at 928. For example, each I/O frame in the queue of I/O frames that is maintained and updated over time as more I/O frames are received from the robot or PLC, may be written to a binary file in persistent memory.

At 932, control copies a bitmap configuration file to memory (e.g., persistent storage), according to a currently selected bitmap configuration. Control then writes a metadata file to memory (e.g., persistent storage) at 936, and displays contents of the queue of I/O frames on a plot on an HMI of a controller, at 940. Some example details of displaying the I/O signals are described above.

Example embodiments described herein may provide various benefits and advantages. In some examples, an assembly line system may include a rivet tool configured to punch rivets into a workpiece (or other suitable automated manufacturing device tools). The rivet tool may be a self-piercing rivet tool including a gearbox, linear motor, receiver and spindle. A control unit (e.g., a PLC controller) may be configured to control and monitor the riveting sequence, including a compressed air control unit, a rivet feeder configured to store and feed rivets to the rivet tool, operation of the rivet tool itself, and a servo controller for regulating the motor of the rivet tool.

The customer's PLC controller may be configured to send and receive I/O signals to the system controller 232 via the field bus module 308, to control different system components and determine current states of those components. A human-machine interface (HMI) on the customer's PLC controller displays values of the I/O signals being sent from and received by the PLC controller and other system components. For example, during equipment line building, commissioning, and system errors, technicians need to troubleshoot timing or logical discrepancies in the handling of Input/Output signals between the customer's PLC/robot and components of the tool system.

In some examples, the PLC and any HMI associated with the PLC may be external to example system controllers described herein. A customer's PLC may or may not include its own HMI distinct from an HMI of a system controller, and may communicate with the system controller 232 which controls one or more tools. For example, the customer's PLC may send IO signals to a system controller via a fieldbus module. Some example control systems described herein may not include a PLC inside of the control system.

Some example embodiments may generally allow users to select specific I/O signals for display over time on an HMI screen of the controller. For example, upon power up the controller may continuously buffer I/O signals in memory (e.g., up to 3 MB of the most recent I/O state changes with a time resolution of 10 milliseconds, or longer or shorter data/time periods). The change buffer may be written to a record file when directly triggered via the HMI by a user, automatically triggered by the occurrence of a fault, etc. Along with the change buffer, the record may also include some metadata with details about the device's current software versions, I/O bitmap configuration, creation date and trigger source.

When a user opens a record, a table may be provided with each I/O signal name, the type (Input/Output), the bitmap location, and number of changes recorded. Users can then select the period, individual signals and order in which they wish to display the selected I/O signals in a timing chart on the HMI screen of the controller. an example plot of the selected I/O signals over time. Each selected signal may be plotted on a separate line over the specified time period, aligned with each of the other I/O signals selected by the user. The line graphs may be displayed on the HMI of the controller (or other suitable linked mobile device or computer), to allow a technician to troubleshoot components of the system by viewing how I/O signals between the components are changing over time.

Some example embodiments may provide advantages over other approaches that simply display an on/off status of each I/O signal in real time, which makes it very difficult for a technician to monitor signal changes in real time. While a live view may have a minimum refresh rate of 250 milliseconds, for example, buffering and display according to some example embodiments may have a signal change resolution as low as 10 milliseconds (or more or less). It is also difficult to track relevant signals in a live view when all I/O values across the entire bitmap are displayed at once on a limited controller HMI screen, and some example embodiments provide advantages by letting users specify only selected signals for display.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
an automated manufacturing tool device of an assembly line;
a fieldbus module in communication with the automated manufacturing tool device; and
a controller including memory configured to store computer-executable instructions, and at least one processor configured to execute the computer-executable instructions to:
receive input/output (I/O) frames via the fieldbus module and maintain a queue of I/O frames in memory, each I/O frame including a status of at least one I/O signal associated with the automated manufacturing tool device; and
in response to a trigger,
write contents of the queue of I/O frames to persistent storage as a binary file,
copy a bitmap configuration file to the persistent storage according to a currently selected bitmap configuration, the bitmap configuration file including at least one parameter of the at least one I/O signal,
write a metadata file to the persistent storage, the metadata file including metadata associated with the queue of I/O frames and the bitmap configuration file, and
display contents of the queue of I/O frames on a plot on a human-machine interface of the controller.

2. The system of claim 1, wherein the trigger is an input received at the human-machine interface to generate a plot of the contents of the queue of I/O frames.

3. The system of claim 1, wherein the trigger is a detected fault in at least one component of the assembly line.

4. The system of claim 3, wherein the trigger is at least one of a detected fault, a detect warning, or a detected event, in the automated manufacturing tool device.

5. The system of claim 1, wherein the bitmap configuration file includes:
a location of each I/O signal within an I/O frame;
a length of each I/O signal within an I/O frame; and
a data type of each I/O signal within an I/O frame.

6. The system of claim 1, wherein the metadata file is stored as a JavaScript Object Notation (JSON) file in persistent storage.

7. The system of claim 6, wherein metadata file includes a timestamp, a trigger source, a firmware version, a file name of the bitmap configuration file, a selected file name of the bitmap configuration file, a duration of the contents of the queue of I/O frames, a name of a stored record, and a checksum of the binary file.

8. The system of claim 1, wherein writing contents of the queue of I/O frames includes writing contents of the queue of I/O frames to a temporary directory in the persistent storage.

9. The system of claim 8, wherein the at least one processor is configured to execute the computer-executable instructions to compress contents of the temporary directory to a zip file in the persistent storage.

10. The system of claim 1, wherein the at least one processor is configured to execute the computer-executable instructions to:
compare a size of the queue of I/O frames to a maximum queue size value; and
in response to the size of the queue of I/O frames reaching the maximum queue size value, replace an oldest I/O frame in the queue with a newest I/O frame in a first-in first-out manner.

11. The system of claim 1, wherein a type of the automated manufacturing tool device is a self-piercing rivet tool or weld tool.

12. The system of claim 1, wherein the at least one processor is configured to execute the computer-executable instructions to:
display a list of bitmap configuration on the human-machine interface for selection by a user;
receive an input selection of a subset of signals from the bitmap configuration; and
display only the subset of signals selected by the user on the plot on the human-machine interface.

13. The system of claim 1, wherein a resolution of the plot is less than or equal to one millisecond.

14. A method comprising:
receiving input/output (I/O) frames via a fieldbus module in communication with at least one of a robot or programmable logic controller (PLC) of an assembly line, and maintain a queue of I/O frames in memory, each I/O frame including a status of at least one I/O signal associated with an automated manufacturing tool; and
in response to a trigger,
writing contents of the queue of I/O frames to persistent storage as a binary file,
copying a bitmap configuration file to persistent storage according to a currently selected bitmap configuration, the bitmap configuration file including at least one parameter of the at least one I/O signal,
writing a metadata file to persistent storage, the metadata file including metadata associated with the queue of I/O frames and the bitmap configuration file, and
displaying contents of the queue of I/O frames on a plot on a human-machine interface.

15. The method of claim 14, wherein the trigger is an input received at the human-machine interface to generate a plot of the contents of the queue of I/O frames.

16. The method of claim 14, wherein the trigger is a detected fault in at least one component of the assembly line.

17. The method of claim 14, wherein the trigger is at least one of a detected fault, a detected warning or a system event, in at least one component of the assembly line.

18. The method of claim 14, wherein the bitmap configuration file includes:
a location of each I/O signal within an I/O frame;
a length of each I/O signal within an I/O frame; and
a data type of each I/O signal within an I/O frame.

19. The method of claim 14, wherein the metadata file is stored as a JavaScript Object Notation (JSON) file in memory.

20. The method of claim 18, wherein the metadata file includes a timestamp, a trigger source, a firmware version, a selected file name of the bitmap configuration file, a duration of the contents of the queue of I/O frames, a name of a stored record, and a checksum of the binary file.
